(19) United States
(12) Patent Application Publication
(10) Pub. No.: US 2005/0174256 A1
(43) Pub. Date: Aug. 11, 2005

(54) Remote disconnect systems for utility meters

(76) Inventor: Eric P Berg, Lakewood, CO (US)

Correspondence Address: Mark R Wisner;WISNER & ASSOCIATES, Suite 400, 1177 West Loop South, Houston, TX, 77027-9012, US

(21) Appl. No.: 09/910,414

(22) Filed: Jul. 20, 2001

Related U.S. Application Data
(63) Continuation-in-part of application No. 09/672,162, filed on Sep. 27, 2000.

(51) Int. Cl. G08C 19/04

(52) U.S. Cl. 340/870.39

(57) ABSTRACT

A wireless remote control system for disconnecting the power in a whole-house utility meter. The user is then able to dial a pager number that is already pre-programmed. The paging service then transmits a signal to a radio frequency (“RF”) receiver in the module. The signal is then decoded and sent to a processor. The processor then causes a relay to open or close in accordance with the decoded signal to connect or disconnect the electrical power.

Related Applications: This application is a continuation-in-part of Ser. No. 09/672,162, filed on Sep. 27, 2000.

### FIELD OF THE INVENTION

This invention is in the field of disconnect systems for electrical power-meters.

### BACKGROUND OF THE INVENTION

Utility meters are widely used by utility companies to monitor the usage of electrical power into residences, offices, and any other sites using electrical power supplied by the utility companies. These meters are typically monitored by visual inspections and the customer billed according to their electrical usage. Often it becomes necessary for the power to be disconnected from the site being served. This may be due to an end of service situation, a chronic no-pay customer, seasonal use of the site being served, turn-over of a site or other situations. Presently, these situations require service personnel to visit the site and manually disconnect the power, such as removing the meter. An additional visit is required then to re-connect the power.

These visits are time-consuming and expensive for the utility companies. Further, the timing may not always be suitable for many situations, such as re-connecting power. An additional problem arises in situations where safety may be of concern.

A previous attempt to solve this problem is disclosed in U.S. Pat. No. 5,668,538, issued to Warwick. This patent discloses a modular electricity meter having a remotely controllable switch. This meter uses a direct telephone connection or a radio signal to activate a solenoid switch. This system requires special installation and either the expense of a direct telephone line or special radio equipment to operate the device.

There presently is a need for a system that will provide remote disconnect/connect of a utility power supply in an inexpensive manner.

### SUMMARY OF THE INVENTION

The present invention solves these problems and others by providing a system for remote disconnect/connection of electrical power into a building. The system, in a preferred embodiment, is a “plug and play” device that is already preprogrammed for operation. The system is integrally mounted within a utility power meter. The power meter is simply plugged into the meter housing and the control board is activated by any touch tone telephone or computer modem. Once the paging service has been activated, the system is ready for operation without the need of complicated installation or programming.

The user is then able to dial a pager number that is already pre-programmed. The paging service then transmits a signal to a radio frequency (“RF”) receiver in the power supply module. The signal is then decoded and sent to a processor. The processor then causes a switching circuit to open or close in accordance with the decoded signal to disconnect or connect the electrical power entering the building. The exemplary embodiments are described using relay switches or other types of switching circuits.

These and other features will be evident from the ensuing description of preferred embodiments and from the drawings.

### BRIEF DESCRIPTION OF THE DRAWINGS

FIG. 1 illustrates a view of a preferred embodiment of the present invention.

FIG. 2 shows a device utilizing the preferred embodiment of FIG. 1.

FIG. 3 illustrates a standard utility power meter set-up.

FIG. 4 illustrates an operational diagram of a preferred embodiment of the present invention.

FIG. 5 illustrates a schematic of the RF receiver, and filter of the preferred embodiment of FIG. 1.

FIG. 6 illustrates a schematic of the decoder circuit of the embodiment of FIG. 1.

FIG. 7 illustrates a command controller unit of the preferred embodiment of FIG. 1.

FIG. 8 illustrates a schematic of the switching circuit, input power supply unit and the output power supply unit of the preferred embodiment of FIG. 1.

### DETAILED DESCRIPTION OF PREFERRED EMBODIMENTS

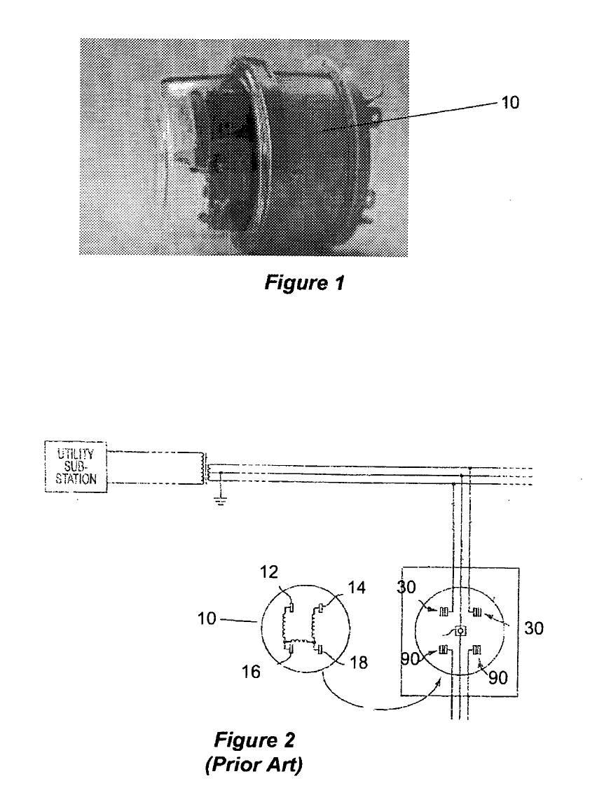

A preferred embodiment of the present invention is illustrated in FIGS. 1-8. It is to be expressly understood that the descriptive embodiments are provided herein for explanatory purposes only and is not meant to unduly limit the claimed inventions. The preferred embodiment of the present invention includes a wireless remote control system for disconnecting/connecting electrical power for houses, buildings and other environments using electrical meters. The preferred embodiment of the present invention has particular utility for seasonal use buildings, apartment complexes with high turn over rates, chronic no pays and for use in safety disconnect environments.

General Overview

In a preferred embodiment, the present invention incorporates a wireless remote control system integrated within an electrical power meter, such as shown in FIG. 1. The integrated utility meters 10, of the preferred embodiment of the present invention, are able to quickly replace existing standard utility meters. The utility meter 10, as shown in FIG. 1 and FIG. 2, meters the flow of electricity from a utility substation into a building, such as a house, office building, apartment complex, etc.

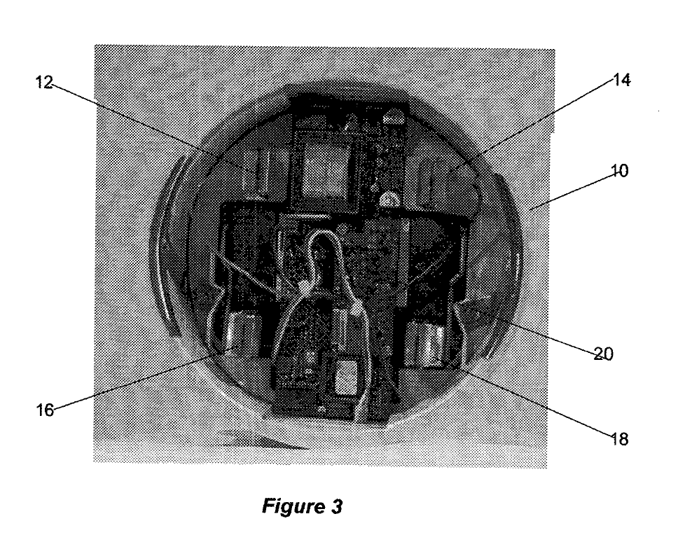

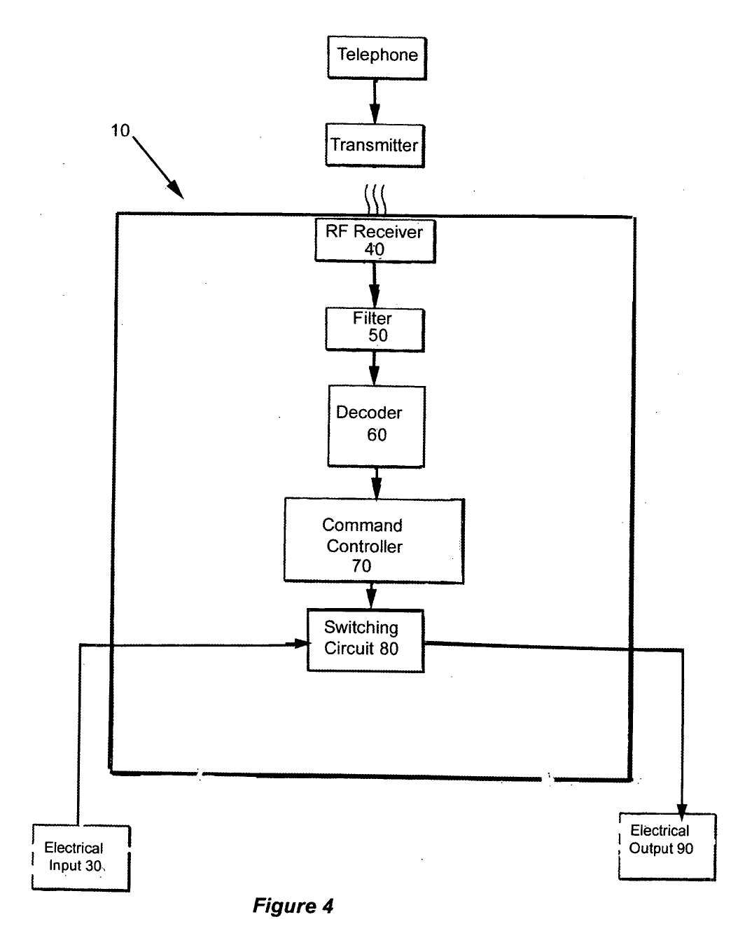

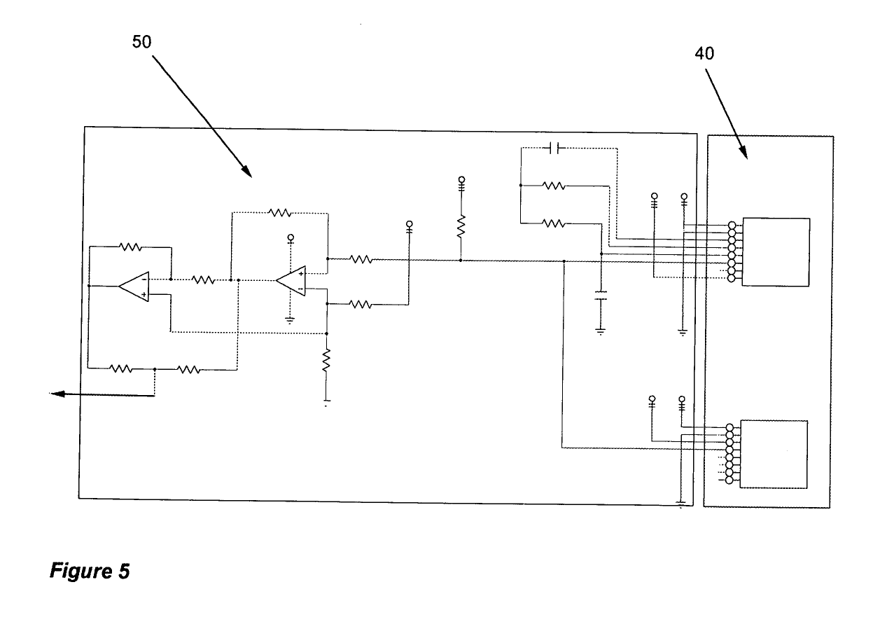

The utility meter 10 includes control board 20, as shown in FIG. 3, integrated directly into the utility meter 10. The control board is shown in an operational diagram in FIG. 4 and schematically in FIGS. 5-8. The control board 20 is connected between the power input loads 12, 14 and power output loads 16, 18.

The remote disconnection/connection system of a preferred embodiment includes an Electrical Input 30, Radio Frequency (“RF”) Receiver 40, Filter Circuit 50, Decoder Unit 60, Command Controller Unit 70, Switching Circuit 80 and Electrical Output 90. Each of these circuits will be discussed in greater detail below.

If the utility company decides to remotely power disconnect the electricity into the building, it only requires a simple telephone call. The user calls an assigned telephone number to a paging service. The user may also use a mobile telephone, a personal computer, or even a personal digital assistant. The paging service then transmits an encrypted signal from a paging transmitter in accordance with standard paging technology. The signal can be transmitted from land or satellite based paging transmitters.

The paging signal is received at the control board 20 by RF receiver 40. The system may use an external antennae if necessary. The received paging signal is then filtered through filter circuit 50 and sent to decoding controller 60. The controller 60 then decodes the signal into a command stream. This command stream is sent to the Command Controller Unit 70.

The Command Controller Unit 70, in accordance with the command stream, then activates the Switching Circuit 80. Switching Circuit 80, in the preferred embodiment, is a relay switch. It is to be expressly understood that other types of circuits may be used as well to enable the switching operation. The Switching Circuit 80 is normally in the closed position so that the fail mode is powered on in the preferred embodiment. In this embodiment the Circuit 80 is in a closed position so the Electrical Output is hot. Thus, the Command Controller Unit 70, upon receiving the command signal processed from the signal sent by the paging transmitter based on the user's call, causes the Switching Circuit 80 to open. The current from the input power unit is interrupted and the Electrical Output 90 is no longer hot.

It is to be expressly understood that the reverse can also be accomplished under the present invention. The Switching Circuit 80 may be maintained normally in the open position so that power is not initially powered to the Electrical Output 90. The user can then power up any device connected to the Electrical Output 90 by simply paging the system, as discussed above. The Switching Circuit 80 is closed to allow current to flow to the main power output 90 to power up the device connect to it.

Specific Implementation of a Wireless Remote Control System

A specific implementation of a wireless remote control activation system, as discussed above, is shown in FIGS. 5-8. It is to be expressly understood that this implementation is being described for explanatory purposes and is not meant to limit the claimed inventions.

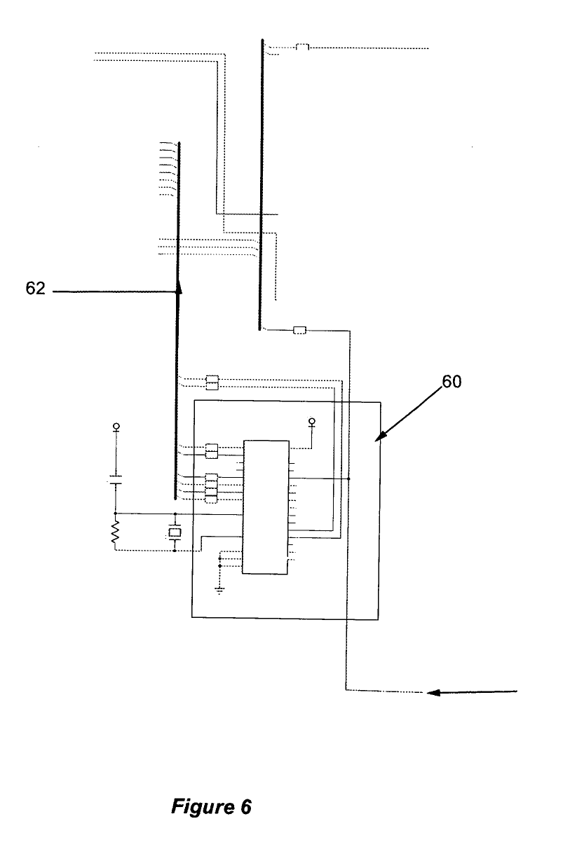

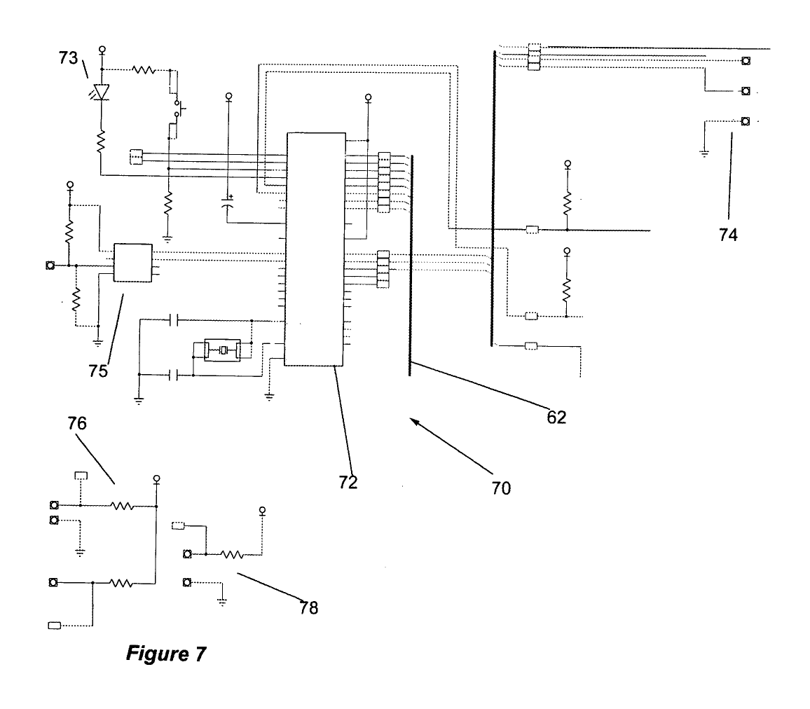

RF Receiver 40 is schematically shown in FIG. 5. The RF Receiver 40 is capable of receiving an RF signal from a paging transmitter (not shown). The paging transmitter can be land-based or satellite based. The RF Receiver 40 may be connected to an external antenna (not shown) if necessary. The paging transmitter transmits the RF signal based upon a user telephoning an assigned telephone number, or from a computer via a modem, personal digital assistant or other known devices for notifying the paging transmitter. The RF Receiver 40 receives the RF signal from the paging transmitter wherein it is sent through Filter 50 to initially process the signal. The filtered signal is then sent to Paging Decoder 60, shown in FIG. 6, that decodes the RF signal from a typical paging protocol format. The transmitted signal is decoded into a digital bit stream and sent onward along buss 62 to the Command Controller 70, shown in FIG. 7.

Command Controller 70 receives the digital bit stream and acts in accordance with the information contained in the stream. The Command Controller 70 includes an integrated processor circuit 72 to process the signal. Controller Unit 70 may also includes an LED (Light Emitting Diode) 73 to display the status of the Unit. The serial interface 74 also allows the Command Controller Unit 70 be updated or reprogrammed. The Unit 70 also includes a buffer memory circuit 75 in the event that the Controller Unit memory bank is full.

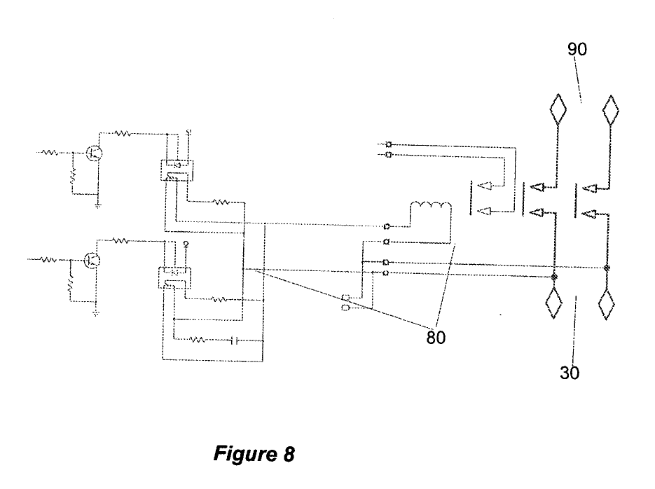

Power Override Circuit 76 (in another preferred embodiment) is provided to allow the Command Controller Unit 70 to be overridden, such as to manually switch the power on or off to the Electrical Output 90. In normal use, the Command Controller Unit 70 transmits a command signal to the Switching Circuit 80, shown in FIG. 8, in accordance with the paging transmitted signal. The Switching Circuit 80, normally held in the closed position would then be reset to the open position to prevent power from flowing to Electrical Output 90. Alternatively, if the failsafe mode is in the open position, then the Switching Circuit 80 would then be closed to allow power to flow to the Electrical Output 90. In this preferred embodiment, Switching Circuit 80 is a relay switch, but other types of switching circuits could be used as well.

It is to be expressly understood that other embodiments may also be within the scope of the present invention to allow power and other transmissions to be controlled by wireless remote control integrated in the utility power meter.

1. A system for remote disconnection and connection for electrical power meters having an input electrical supply source and an output electrical circuit, said system comprising:
a switching circuit connected between said input electrical supply source and said output electrical circuit;
a receiver for receiving control signals from a remote source; and
a processor for processing said control signals from said receiver to open said switching circuit to interrupt electrical power transmission between said input electrical supply source and said output electrical circuit.

2. The system of claim 1 wherein said receiver includes:
a radio frequency receiver for receiving wireless radio frequency signals from a paging transmitter.

3. The system of claim 2 wherein said system further includes:
a decoder processor to decode the signal received from said radio frequency receiver from said paging transmitter into a control signal for said processor.

4. The system of claim 1 wherein said system further includes:
said switching circuit, said receiver and said processor are integrally mounted within the electrical power meter.

5. A method for remote control for disconnecting and connecting electrical power using a system having an input electrical supply source; an output electrical outlet; a switch connected between said input electrical supply source and said output electrical outlet; a receiver for receiving control signals from a remote source; and a processor for processing said control signals from said receiver to open said switch to interrupt electrical power transmission between said input electrical supply source and said output electrical outlet, said method comprising the steps of:
transmitting a paging signal to said receiver from a remote paging transmitter in accordance with a page from a remote user;
sending said transmitted signal to said processor for relaying a command signal to said switch; and
operating said switch in accordance with said command signals from said processor to interrupt and connect the connection between said input electrical source and said output electrical outlet to control the power to the electrical device.
